(19) United States
(12) Patent Application Publication
(10) Pub. No.: US 2011/0219698 A1
(43) Pub. Date: Sep. 15, 2011

(54) WINDOW RETAINER BELT

(75) Inventor: Michel MORIN, Sherbrook (CA)

(73) Assignee: Plastech, Sherbrooke (CA)

(21) Appl. No.: 13/047,135

(22) Filed: Mar. 14, 2011

(30) Foreign Application Priority Data
Mar. 15, 2010 (CA) 2696148

(51) Int. Cl. E06B 7/16; B29C 45/00; B29C 69/00; B29C 53/02

(52) U.S. Cl. 49/483.1; 264/295

(57) ABSTRACT

A method for fabricating a window retainer belt comprising a channel engaging edge of a window pane and a channel engaging a finish of an opening for the window pane in a body, comprising injection molding, in a single mold, a first U-shaped channel extending into a second upside down U-shaped channel, with a retention lip extending from a first inner wall of the first U-shaped channel towards an opening of the first U-shaped channel; demolding; and folding back the retention lip within the first U-shaped.

### CROSS REFERENCE TO RELATED APPLICATIONS

This application claims benefit of Canadian application serial No. 2,696,146, filed on Mar. 15, 2010. All documents above are incorporated herein in their entirety by reference.

### FIELD OF THE INVENTION

The present invention relates to window retainer belts. More specifically, the present invention is concerned with injection molded window retainer belts.

### BACKGROUND OF THE INVENTION

Fabrication of a door of a vehicle body with a slidable window pane involves assembling a plurality of components and finish parts. The frame of the door, at the location where the window pane slides inside the door body, is provided, one each side, with a strip referred to as a belt. Typically, there is an outer belt, on the side of the door frame facing the exterior of the vehicle, an inner belt on the side of the door frame facing the inside of the vehicle, the belts making the alignment of the window, and being in direct contact with the window pane as it slides up and down.

Window retainer belts are standardly fabricated by extrusion. They comprise a channel engaging the edge of the window pane and a channel engaging the interior finish of the door body made in rigid ethylene-propylene terpolymer (EPDM). The channel engaging the edge of the window pane is sometimes reinforced with embedded metallic wires.

Once the strip is extruded, a number of secondary steps are still needed to achieve a finished window retainer belt. Flocking is added on sliding lips of the channel engaging the edge of the window pane. Then the strip may need to be cut off to its final length and a sealing joint, generally made in foam, may be secured on one of both of its extremities. When complex shapes are required, the strip must further be adjusted by providing adequate cut-outs along the length thereof. Foam strips may further have to be added between the sealing lips to enhance tightness.

There is still a need in the art for a method for fabricating window retainer belts.

### SUMMARY OF THE INVENTION

More specifically, there is provided a method for fabricating a window retainer belt comprising a channel engaging edge of a window pane and a channel engaging a finish of an opening for the window pane in a body, comprising injection molding, in a single mold, a first U-shaped channel extending into a second upside down U-shaped channel, with a retention lip extending from a first inner wall of the first U-shaped channel towards an opening of the first U-shaped channel; demolding; and folding back the retention lip within the first U-shaped.

There is further provided a method for fabricating a window retainer belt, comprising, in a single mold, injection molding, in a rigid thermoplastic material, a first U-shaped channel extending into a second U-shaped channel oriented upside down relative to the first U-shaped channel; and, in a flexible thermoplastic material, a lip extending from a first inner wall of the first U-shaped channel towards an opening of the first U-shaped channel; and demolding.

There is further provided an injected molded window retainer belt, comprising a first channel, comprising a sliding lip on a first outer surface thereof; a cantilevered lip extending from a first inner wall of the first channel to a direction opposite an opening of the first channel within the first channel; and ribs on a second inner wall of the first channel opposite the first inner wall of the first channel; a second channel, extending from a second outer surface of the first channel opposite the first outer surface of the first channel, and generally upside down relative to the first channel; wherein the first and second channels are made in a rigid thermoplastic material and the sliding lip, the second inner wall and the cantilevered lip are made in flexible thermoplastic materials.

Other objects, advantages and features of the present invention will become more apparent upon reading of the following non-restrictive description of embodiments thereof, given by way of example only with reference to the accompanying drawings.

### BRIEF DESCRIPTION OF THE DRAWINGS

In the appended drawings:

FIG. 1 is a section of a window retainer belt according to an embodiment of an aspect of the present invention;

FIG. 2 is a perspective sectional view of the window retainer belt of FIG. 1 upon exciting the injection mold; and

FIG. 3 is a perspective view of the window retainer belt of FIG. 1.

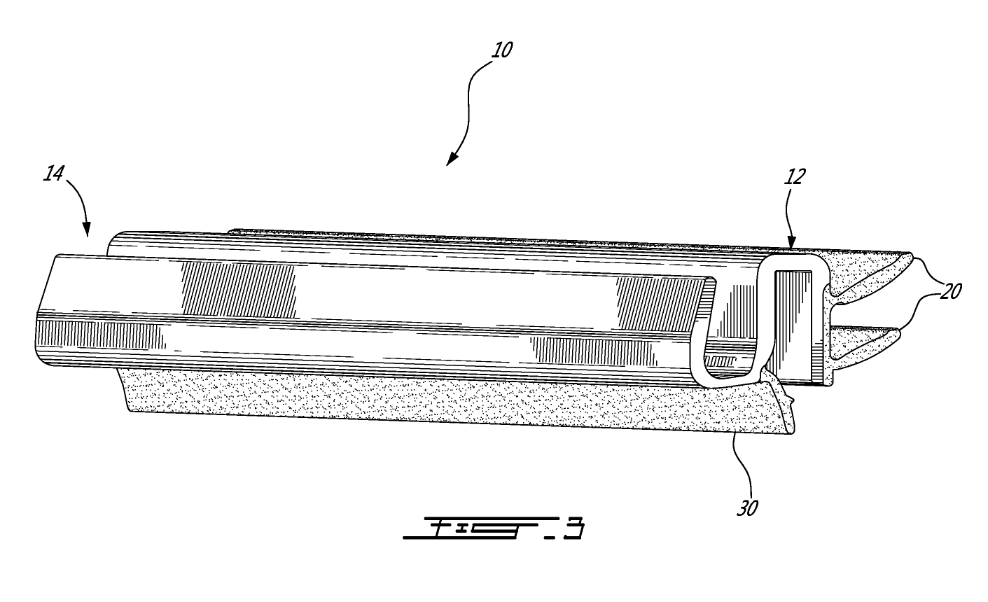

### DESCRIPTION OF EMBODIMENTS OF THE INVENTION

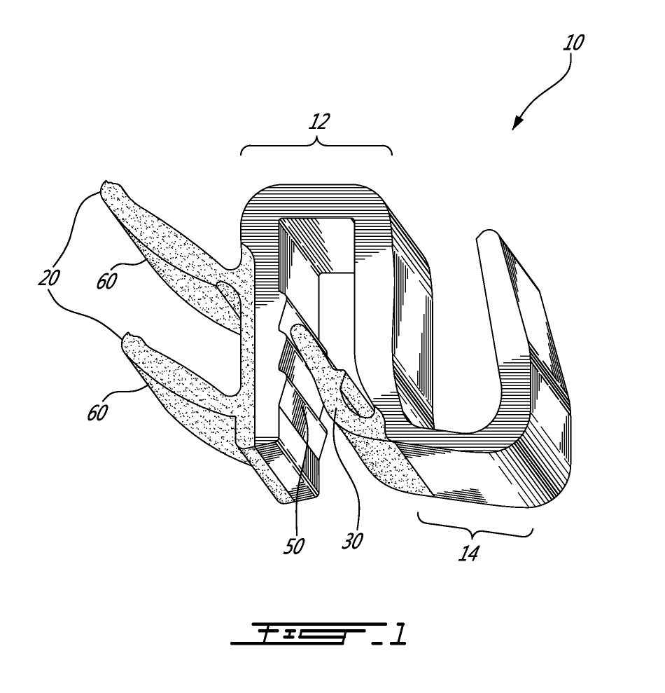

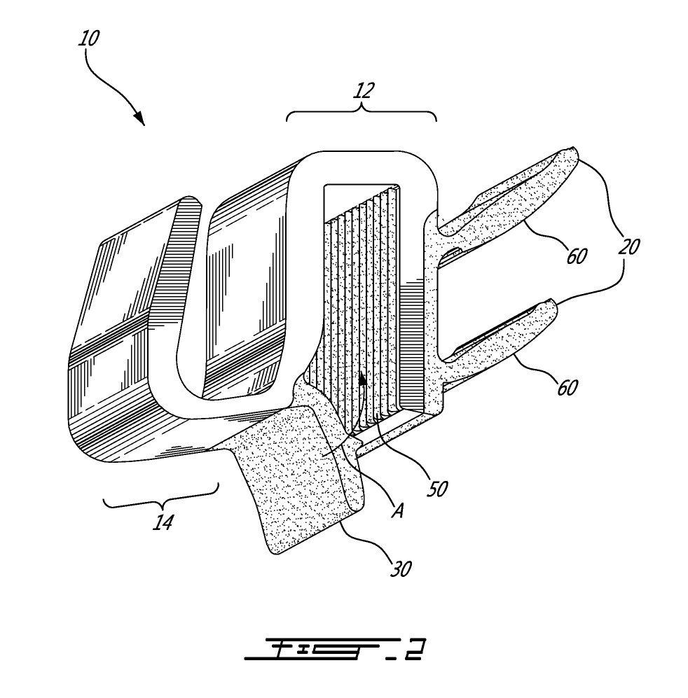

According to an embodiment of an aspect of the present invention, as illustrated for example in FIGS. 1 and 2 of the appended drawings, a window retainer belt 10 is a strip of material comprising a channel 12 engaging the edge of a window pane (not shown), and a channel 14 engaging the finish of an opening in a body intended to receive the window pane, such as the door of a vehicle (not shown).

The channel 12 engaging the edge of the window pane is generally U-shaped and extends, on one side thereof, into the channel 14 engaging the finish of the door body. The channel 14 is in the shape of an upside-down U relative to the U formed by the channel 12.

The free outer surface of the channel 12 comprises sliding lips 20. The surface of the sliding lips 20 in contact with the window pane (not shown) is covered by a flocking 60. A retention lip 30 extends in the inside of the channel 12, as a cantilevered finger extending from an inner wall of the channel 12 towards the closed end of the channel 12. The opposite inner wall of the channel 12 is provided with ribs 50, which may be adjusted, in number and size depending on a required insertion/extraction force, thereby forming a retention surface.

The retention lip 30 and the ribs 50 on the retention inner wall of the channel 12 participate in preventing extraction of the window retaining belt from the frame of the vehicle, once in place.

Both channels 12 and 14 are injection molded, typically in a rigid thermoplastic material such as polypropylene, acrylic, polycarbonate or ABS, for example. The sliding lips 20, the retention surface of the channel 12 and the retention lip 30 are injection moulded in a flexible thermoplastic material such as, for example, thermoplastic elastomer (TPE), thermoplastic vulcanizate (TPV), polyvinyl chloride (PVC) or thermoplastic polyurethane (TPU).

According to an embodiment of an aspect of the present invention, a method for fabricating a window retainer belt comprises molding, in a single mold, a belt comprising a first U-shaped channel, with sliding lips extending from its free outer surface, this first U-shaped channel extending, opposite this free outer surface, into a second upside down U-shaped channel.

A lip is simultaneously molded, extending, from a first inner wall of the first U-shaped channel, towards the opening of the first channel, while ribs are formed, within the mold, on the opposite inner wall of the first U-shaped channel.

Prior to molding, flocking is positioned within the mold, on surfaces corresponding to the molding area for the sliding lips, so that the inner surfaces of the sliding lips are covered with flocking within the mold.

Since the flocking, as well as the sliding lips, are typically made in a material based on polypropylene for example, they melt upon molding the strip and are overmolded over the strip, within the mold.

As people in the art will appreciate, not only the flocking, but also any desired foam sealing joints or complex geometrical features may be molded together with the strip itself, within the mold.

Upon demolding, the lip extending from the inner wall of the first U-shaped channel is folded back (see arrow A in FIG. 2) towards the closed end of the first U-shaped channel within the channel, manually for example, thereby forming a retention lip. The window retainer belt is then complete. It has its final length upon demolding, and does not require a further step of length adjustment.

The resulting window retainer belt is rigid enough and there is no need for reinforcing wires as added in extrusion processes using EPDM or rubber for example.

The present method, by allowing injection of the window retainer belt in one step within a single mold, allows fabricating, in one run, finished window retainer belts, even with complex geometries, within a range of weight comprised between a few grams to kilograms depending on the available press and mold.

As people in the art will appreciate, the present method eliminates most of secondary steps needed in extrusion methods in order to achieve a suitable window retainer belt, which in turn results in a sharp decrease of production costs.

The provision of an adjustable retention inner surface on an inner wall of the first U-shaped channel, by forming ribs of an adjustable number and shapes for example, allows tailoring the window retainer belts depending on target retention/extraction forces needed to secure the inner belt into position with respect to the frame of the vehicle.

Although the present invention has been described hereinabove by way of embodiments thereof, it may be modified, without departing from the nature and teachings of the subject invention as defined in the appended claims.

What is claimed is:

1. A method for fabricating a window retainer belt comprising a channel engaging edge of a window pane and a channel engaging a finish of an opening for the window pane in a body, comprising:
injection molding, in a single mold, a first U-shaped channel extending into a second upside down U-shaped channel, with a retention lip extending from a first inner wall of the first U-shaped channel towards an opening of the first U-shaped channel;
demolding; and
folding back the retention lip within the first U-shaped.

2. The method of claim 1, wherein said injection molding comprises molding sliding lips extending from a free outer surface of the first U-shaped channel opposite the second first U-shaped channel.

3. The method of claim 1, wherein said injection molding comprises molding ribs on a second inner wall opposite the first inner wall of the first U-shaped channel.

4. The method of claim 2, comprising, prior said injection molding, positioning flocking within the mold on surfaces corresponding to a molding area for the sliding lips.

5. The method of claim 1, wherein said injection molding comprises molding foam sealing joints.

6. The method of claim 1, wherein said injection molding comprises molding additional complex geometrical features of the belt.

7. The method of claim 1, wherein said injection molding comprises forming an adjustable retention inner surface on a second inner wall opposite the first inner wall of the first U-shaped channel.

8. The method of claim 1, wherein said injection molding comprises forming the first and second U-shaped channels with a rigid thermoplastic and the retention lip with a flexible thermoplastic material.

9. The method of claim 2, wherein said injection molding comprises forming the first and second U-shaped channels with a rigid thermoplastic, and forming the retention lip and the sliding lips with a flexible thermoplastic material.

10. The method of claim 3, wherein said injection molding comprises forming the first and second U-shaped channels with a rigid thermoplastic, and forming the retention lip and the ribs with a flexible thermoplastic material.

11. A method for fabricating a window retainer belt, comprising:
in a single mold, injection molding, in a rigid thermoplastic material, a first U-shaped channel extending into a second U-shaped channel oriented upside down relative to the first U-shaped channel; and, in a flexible thermoplastic material, a lip extending from a first inner wall of the first U-shaped channel towards an opening of the first U-shaped channel; and
demolding.

12. An injected molded window retainer belt, comprising:
a first channel, comprising a sliding lip on a first outer surface thereof; a cantilevered lip extending from a first inner wall of the first channel to a direction opposite an opening of said first channel within said first channel; and ribs on a second inner wall of the first channel opposite said first inner wall of the first channel;
a second channel, extending from a second outer surface of said first channel opposite said first outer surface of the first channel, and generally upside down relative to said first channel;
wherein said first and second channels are made in a rigid thermoplastic material and said sliding lip, said second inner wall and said cantilevered lip are made in flexible thermoplastic materials.

13. The injected molded window retainer belt of claim 12, wherein said sliding lip has a surface covered by a flocking.

14. The injected molded window retainer belt of claim 12, wherein said rigid thermoplastic material is one of polypropylene, acrylic, polycarbonate or ABS; and said flexible thermoplastic materials are one of thermoplastic elastomer (TPE), thermoplastic vulcanizate (TPV), polyvinyl chloride (PVC) or thermoplastic polyurethane (TPU).
